(19) United States
(12) Patent Application Publication
(10) Pub. No.: US 2006/0084175 A1
(43) Pub. Date: Apr. 20, 2006

(54) Colorimetric strip containing coomassie blue for semi-quantitation of albumin

(76) Inventor: Wayne Comper, New York, NY (US)

Correspondence Address: MCDERMOTT WILL & EMERY LLP, 600 13TH STREET, N.W., WASHINGTON, DC, 20005-3096, US

(21) Appl. No.: 10/967,276

(22) Filed: Oct. 19, 2004

(51) Int. Cl. G01N 31/22

(52) U.S. Cl. 436/88; 422/56

(57) ABSTRACT

A test strip for semi-quantitatively measuring amount of albumin in a urine sample is provided. The test strip contains Coomassie Brilliant Blue on a test pad area which is wetted with the urine sample, providing a color change in the presence of protein. The color that develops at the test pad area is compared to a color reference determined by correlating the amount of total protein detected in a standard sample by Bradford assay with the amount of total albumin determined in the sample by HPLC.

### FIELD OF THE INVENTION

This invention relates to an apparatus and methods for detecting albumin in urine, which is predictive of renal disease and/or renal complications of a disease, using a Coomassie Blue based assay to estimate total urinary albumin including immunoreactive and immunounreactive albumin. More particularly, the invention relates to a rapid, semi-quantitative test strip and methods for estimating total urinary albumin.

### BACKGROUND OF THE INVENTION

The earliest sign of kidney and cardiovascular disease is the presence of albumin in the urine. Accumin™, an HPLC-based albumin assay, is the most accurate commercial test available for detecting intact albumin in urine of kidney and cardiovascular disease.

In general, conventional assays that use antibodies raised to native albumin (serum albumin)_do not detect all intact albumin present in urine, because modifications of kidney filtered albumin often mask epitopes recognized by such antibodies. As a result, the amount of urinary albumin detected by such immunoassays is significantly less than detected by an HPLC-based assay, which detects both immunoreactive albumin and theepitope-masked, immunounreactive albumin. Thus, tests based on immunoreactivity do not detect albumin in urine until significantly later in kidney or cardiovascular disease than the HPLC-based test.

Commercially available anti-human serum albumin (HSA) antibodies are unable to detect immunounreactive, or “ghost”, albumin (ghAlb). Therefore it has not been possible to develop an immunoassay system for urinary total albumin. Antibodies to serum (native) albumin do not detect albumin in the urine until the later stages of kidney or cardiac disease, maybe after irreparable organ damage has occurred.

HPLC-based assays, although more accurate than conventional immunoassays assays for measuring total urinary albumin is time consuming and relatively expensive, requiring doctor appointments and laboratory analysis, in order to determine results. Consequently, a need exists for a more rapid, easily administered and analyzed assay for the presence of albumin in urine that detects total (immunoreactive and immunounreactive) albumin during the early stages of kidney disease or malfunction or cardiovascular disease, i.e., prior to irreversible kidney or heart damage.

Dye-based assays, such as dye-based test strips for protein detection also fail to detect immunounreactive albumin in urine. For example, dyes commonly used to detect albumin, e.g., sulfonephthalein dye which is used on Bayer's Microalbustix, and Bayer's Clinitek do not react with immunounreactive intact albumin. Consequently, these test strips fail to detect albumin in urine during the early stages of renal disease or malfunction or early stages of cardiovascular disease.

Thus, there is a need for a disposable, easily administered assay to detect and estimate small amounts of total urinary protein as an indication of kidney disease or cardiovascular.

### SUMMARY OF THE INVENTION

The invention provides a test strip for detecting and semi-quantitating the amount of albumin in a bodily sample, such as a urine sample. The test strip comprises a reagent area having an amount of Coomassie Blue dye immobilized and dried onto it such that when the pad is dipped into the sample or a sample is applied directly to the reagent area, a color change occurs. The resulting color is read against a color standard which relates the amount of protein detected by the Bradford assay to the standard amount of intact albumin detected by HPLC, which is an accurate measure of amount of albumin in a test sample. The resulting color is directly proportional to the amount of intact albumin present in the sample.

In one aspect of the invention there is provided a colorimetric test strip for detecting and semi-quantitating the amount of total albumin in a bodily sample comprising a test strip matrix, and at least one reagent area disposed on the test strip matrix comprising Coomassie Blue dye, wherein the at least one reagent area changes color shade after exposure to the sample, wherein the amount of total albumin is determined by comparing the at least one reagent area color shade after exposure to the sample to at least one reference color, said at least one reference color correlating the amount of protein determined by Bradford assay to the amount of albumin determined by HPLC.

In another aspect of the invention there is provided a method for detecting and semi-quantitating the amount of albumin in a bodily sample comprising:
(a) obtaining a bodily fluid sample;
(b) contacting the bodily fluid sample with a test strip matrix having disposed thereon at least one reagent area comprising Coomassie Blue dye, wherein the at least one reagent area changes color shade after contact with the sample;
(c) comparing the at least one reagent color shade after contact with the sample with at least one reference color that correlates the amount of protein determined by Bradford assay to the amount of albumin determined by HPLC.

In another aspect of the invention there is a color reference corresponding to an estimated amount of total urine in a sample, determined by correlating the amount of total protein detected in a standard sample by Bradford assay with the amount of total albumin detected in the sample by HPLC.

### BRIEF DESCRIPTION OF THE DRAWINGS

FIG. 1 shows a perspective view of a test strip of the invention. (1) is the test strip matrix; (2) test pad (reagent area).

FIG. 2(A-B) illustrates the variation of the amount of protein determined by the Bradford assay (expressed as a ratio of total protein to creatinine in units of mg/mmol) compared to the ratio of total albumin determined by HPLC (expressed as the ratio of albuminto creatinine) for urine samples containing relative low amounts of total albumin (FIG. 2A) and in urine samples containing relative high amounts of total albumin (FIG. 2B).

FIG. 3 illustrates the average result of color discrimination on a test strip after urine testing and five minutes of color development.

### DETAILED DESCRIPTION OF THE INVENTION

The present invention provides a simple and accurate calorimetric test strip and method for measuring urinary albumin in a bodily fluid such as urine. Briefly, one or more reagent areas of the test strip of the invention is dipped into a sample, e.g., urine sample or a small amount of sample is applied to the test strip onto the reagent area(s) and color development at the reagent area(s) is compared to a reference color or colors to determine an estimate of the amount of albumin present in the sample.

The present inventor has discovered that the Bradford assay, which is a calorimetric test tube assay for detecting protein and which contains Coomassie Blue as a protein indicator, detects both immunoreactive and immunounreactive forms of albumin. The Bradford assay has been adapted to a test strip which detects urinary albumin at a sensitivity that strongly correlates with the results obtained using an HPLC-based assay, i.e., Accumin™.

In addition to detecting immunoreactive and immunounreactive forms of albumin in urine, the Coomassie Blue-based Bradford assay also detects any other protein that is present. However, given that other proteins are at relatively low concentration compared to albumin in urine, Coomassie Blue is useful for the detection of total urinary albumin using a correction factor developed by the inventor that correlates the amount of protein detected by Coomassie Blue with the amount of urinary albumin detected by an HPLC-based assay. The correction factor is used to provide color standards against which the test strip color development is compared to determine an estimate of the amount of albumin in a urine sample.

The test strip of the invention is designed to utilize the Bradford Reagent, which produces a calorimetric change when reacted with proteins in a biological solution in conjunction with a correction factor which relates the amount of protein detected by the Bradford assay to the corresponding amount of albumin detected by HPLC. The Bradford reagent is preferably dried and stabilized onto a test pad adhered to at least one end of a solid support matrix. The support matrix may be composed of any suitable material such as plastic or polystyrene, for example. The change in color of the reagent area on the test pad upon reacting with protein is directly proportional to the concentration of protein in the patient sample. The color intensity that develops on the test strip may be determined visually or by a reflectance-based reader, for example. The color intensity that develops on the test strip is compared to at least one, and preferably at least two standard color shades that correspond to a range of albumin concentration determined by application of a correction factor.

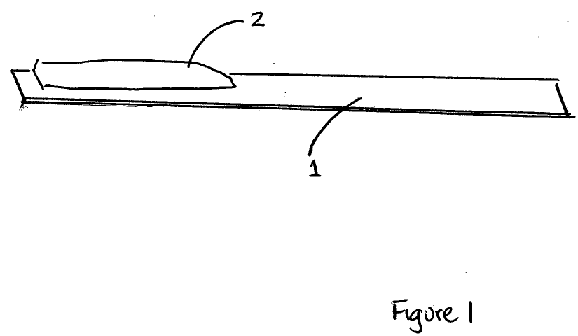

The test strip may be manufactured in any size and shape, but in general the strip matrix is longer than wide and is preferably made of firm or stiff materials, e.g., polyethylenesulfone (Supor), cellulose, mixed synthetic fibers, polycarbonate, polypropylene material, charged membranes and glass fibers, and the like. The test strip matrix may be washed with acid or base to remove undesired material to reduce background or endogenous color. In a preferred embodiment, the test strip is a plastic or polystyrene backed strip having a reagent test pad adhered to at least one end. An embodiment of a test strip of the invention is shown in FIG. 1.

The test pad onto which the Bradford Reagent is absorbed and dried, is preferably made of a membrane material that shows minimal background color. Preferably, the test pad may be constructed of acid or base washed materials in order to minimize background color. Background color has been observed with several types of membrane materials tested under various conditions (such as pH, concentration etc)—including polyethylenesulfone, cellulose,mixed synthetic fibers, polycarbonate, polypropylene and glass fiber materials. When such materials are used to form the test pad, it is preferable that color development is detected by use of a reflectance meter having an LED in the range of about 590 to about 660 nm, rather than visually.

In one embodiment, a glass fiber test membrane is used to form the test strip matrix. Because glass membrane tends to absorb material non-uniformly, the addition of polymers, or gels such as polyethylene glycol, polyvinylpyrolidine (PVP), Klucel, Luviskol K-30, or Bioterg A-40 in the reagent area is preferred in order to coat the test pad membrane uniformly and produce uniform color, which is preferred for good color discrimination in performing tests.

The active color-changing protein indicator of the Bradford Reagent is the dye, Coomassie Brilliant Blue G-250 (“Coomassie Blue”). Coomassie Blue in the appropriate acid medium provides a protein assay reagent having a sensitivity approximately 100 times greater than other protein detection methods, including, the biuret (Mokrasch, L. C., and McGilvery, r. W. (1956) J. Biol. Chem. 221, 909-917) and conventional dye binding techniques, and about three to five times that of the Lowry method (Lowry, Oh. H., Rosenbrough, N. J., Farr, A. L., and Randall R. J. (1951) J. Biol. Chem. 193, 265-275). (U.S. Pat. No. 4,023,933). Moreover, unlike other dye-based assays, the Bradford assay detects both immnuoreactive and immunounreactive forms of albumin.

The acid ingredient of the Bradford Reagent preferably has a pKa of from 0 to 4, more preferably from 1 to 2, and the resultant dye-containing solution preferably has a pH of from −1 to 1, preferably −0.5 to 0.5. Suitable acids include phosphoric acid and other acids with a pKa from 1-2 which do not result in protein precipitation. Typical candidates include acetic, periodic, phosphoric, selenic, sulfurous, maleic, oxalic, dichloroacetic acids and the like, and any combination of one or more. Phosphoric acid is especially preferred. Preferably, phosphoric acid, acetic acid or maleic acid are used.

The Coomassie Blue and acid solution may be dissolved in any aqueous medium that preferably does not contain surfactants, detergents, or exceedingly strong alkali, preferably water. The final concentration of the Coomassie Blue dye in the Bradford Reagent is preferably from about 0.001 to about 0.1% (w/v), more preferably from about 0.005 to about 0.05% (w/v); while that of the acid is preferably from about 4 to about 12% (w/v), more preferably from about 7.5 to about 9.5% (w/v). The order of addition of the dye and acid is immaterial and both may be added directly to the aqueous medium or may be added to separate portions of the medium and thereafter mixed.

In a preferred embodiment, the Bradford Reagent which is dried onto the test strip of the invention further comprises a buffer to prevent color changes resulting from changes to pH in the absence of urinary protein. Coomassie Blue is a pH indicator and contains an ionizable group which is displaced in the presence of protein to provide a detectable color change. This is the same color change that Coomassie Blue would undergo under the influence of a pH change. As such, preferably there is a buffer, such as for example, maleic acid, phosphoric acid, and the like, in the Bradford Reagent to thereby avoid a pH increase which might cause a color change in the absence of protein, thereby resulting in a false positive result.

In another embodiment the Bradford Reagent which is dried onto the test strip further comprises wetting agents to reduce brittleness of the test pad membrane. Non-limiting examples of preferred wetting agents include TritonX-100, Bioterg, glycerol, 0 Tween, and the like.

The concentration of the Bradford Reagent required on a dry pad is sufficient to allow discrimination in color development between 10 to 200 mg/L albumin concentration. Preferably, the test strip contains about 0.01 to about 1% of the Bradford Reagent, with a preferred range of about 0.01% to about 0.03%.

The Bradford Reagent can be applied to the test strip by any method known in the art. For example, membranes from which the test strip pad are made may be dipped into a solution of the Bradford Reagent and dried, preferably in an oven at about 45 to about 75° C. for about five to about 45 minutes. Preferably, reagents are dried onto the membrane at about 60° C. within about 30 to about45 minutes.

The membranes onto which the Bradford Reagent has been applied can be cut in to any dimension to be affixed to a test strip holding device. For example, a test pad having dimensions of about 5 mm×5 mm or the like is fixed onto a 5 mm×40 mm in plastic or polystyrene matrix which forms the test strip. In one embodiment, two test pads may be adhered on a single test strip to allow discrimination between high and low protein levels, as a procedural control, to achieve appropriate controlled acidic environments or to test other analytes such as creatinine or glucose in the test sample.

The amount of total albumin in a sample is determined by comparing the resulting color on the test pad area(s) of a test strip after dipping the test pad into a sample or applying the sample to the test pad(s) area of the test strip to at least one color standard. The color standard of the invention was determined by measuring the amount of total protein in urine samples containing a wide range of total albumin using the Bradford assay and measuring the amount of albumin in the urine samples by HPLC. The amount of protein detected by the Bradford assay and HPLC is preferably normalized by expressing the amounts of protein or albumin as a protein(albumin) to creatinine ratio. Quantitaive albumin excretion is preferably expressed as a ratio of albumin to creatinine to allow for variation in urine flow rates which in turn can alter albumin concentration. The amount of total protein measured by the Bradford Assay was plotted against the amount of albumin measured by HPLC for test samples containing relative high and low amounts of total albumin (immunoreactive and immunounreactive albumin). The results of the comparison of Bradford protein and HPLC total albumin are shown in 2 (A and B). The drawn lines in the figures represent the confines of the data.

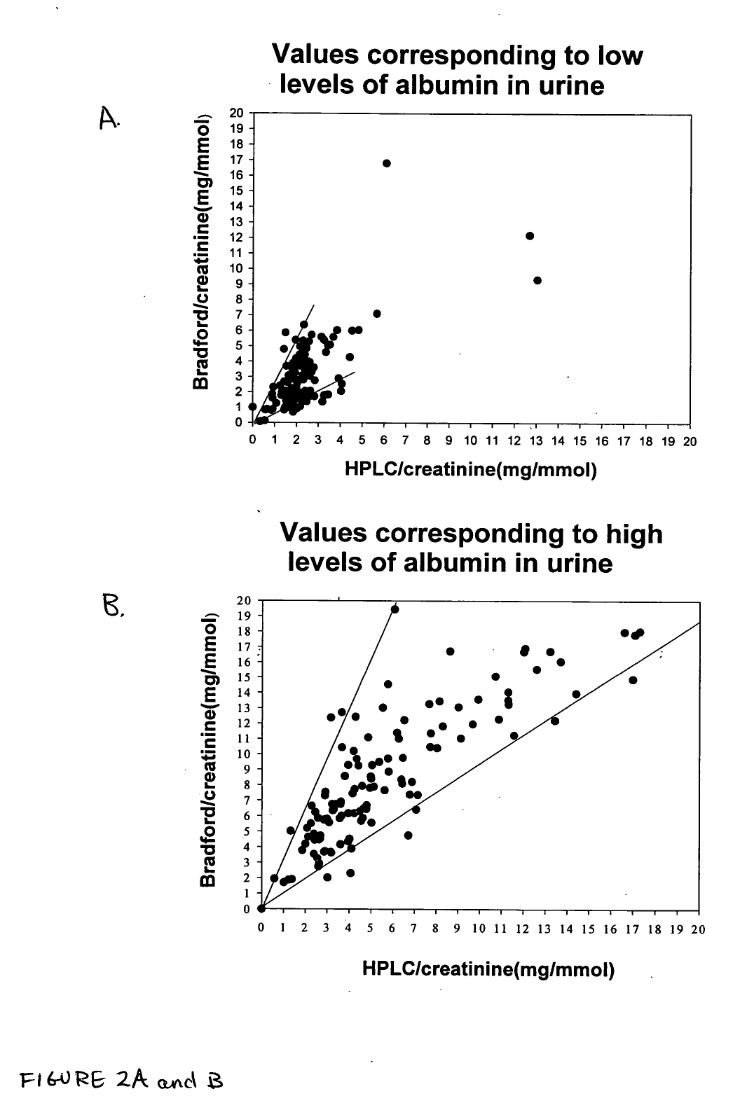

As can be seen from FIGS. 2A and B, the major portion of the data is defined in terms of a conversion factor (CF) defined as:

Total Albumin (immunoreactive plus immunounreactive)=Bradford result/CF where CF is in the range of from about 0.95 to about 3.4.

FIGS. 2A and B illustrate the variation of the amount of protein as determined by the Bradford assay (expressed as a ratio of Bradford to creatinine with units of mg/mmol) as compared to the ratio of total intact albumin as determined by HPLC (expressed as the ratio HPLC to creatinine) for urine samples from different individuals containing relative low amounts of total intact albumin and urine samples containing relative high amounts of total intact albumin. Normal albumin excretion has a value of albumin/creatinine ratio <3.5. Quantitative albumin excretion is preferably expressed as a ratio to creatinine to allow for variation in urine flow rate which in turn will alter albumin concentration.

The range of the conversion factor may preclude accurate quantitative estimation of total urinary albumin by the Bradford assay, but this conversion range is useful for semi-quantitaive estimation of total urinary albumin in the test strip format. The results show that normal albumin excretion observed in healthy individuals has an albumin:creatinine ratio value of less than 3.5 by HPLC (see FIG. 2), which corresponds to a Bradford protein:creatinine ratio of less than 5.5. Conversely, the data show that abnormal excessive albumin excretion results in an albumin:creatinine ratio of greater than 3.5 by HPLC measurement, which corresponds to a Bradford protein:creatinine ratio of greater than 5.5.

In any measuring format if the protein concentration as determined by the Bradford assay is divided by a conversion factor in the range of about 0.95 to about 3.4, preferably in the range of from about 1.5 to about 1.7, and most preferably about 1.6, then the quantity of total intact albumin can be determined. Therefore charts can be constructed to have the conversion factor already factored in so that the color that develops on the test pad after exposure to a urine sample, visually read, can be compared to the chart representing the total amount of intact albumin concentration in the urine. Similarly, by utilizing software containing a calibration curve that translates color intensity into protein concentration with the conversion factor, the instrument provides a digital read-out of total intact albumin concentration.

The conversion factor is used to develop one or more reference colors for comparison with the color development observed on the test strip after exposure to a test sample. The color shade of the reference colors correspond to the predetermined numerical value for albumin. For example, albumin content in a sample is determined to be in the healthy range, i.e., less than 3.5 mg/mM (HPLC) or 5.5 mg/mM Bradford) by comparing the color shade that develops on the test pad with a range of reference colors provided with the strip. Conversely, albumin content in a sample is determined to be in the abnormal, i.e., greater than 3.5 mg/mM (HPLC) or greater than 5.5 mg/mM Bradford) by comparing the color shade that develops on the test pad with a range of reference colors provided with the strip. The reference color shade corresponding to a particular value for albumin content is the darkest shade of color development detected for that particular value.

The conversion factor of Bradford to total intact albumin may be used to design a semi-quantitative estimate of total intact albumin in other formats, such as lateral flow devices or similar devices that are made to come in contact with urine. Such devices may have the Bradford reagent in a format which undergoes a color change depending on the amount of protein in the urine. This color change can be converted to total intact albumin estimate based on prior calibration of the Bradford assay with total intact albumin as determined by HPLC.

Color develops on the test pad area onto which the Bradford reagent is dried within about one to about ten minutes, preferably within about two to about six minutes and most preferably, within about five minutes. Timing of the test can be further reduced by optimizing the concentration of Bradford reagent.

In a similar fashion, a range of conversion factors to estimate total albumin content of a urine sample may be developed for use with other assays based on protein detecting dyes such as pyrogallol, biuret, bicinconinic and sulfosalicylic acid, for example. The amount of total protein in a sample is measured using the dye-based assay, which may be in a dipstick format, and the amount of total protein detected is compared to the amount of albumin detected by HPLC. The assays are carried out as above, using different test samples containing high and low concentrations of albumin and the results of the assays are compared. A range of conversion factors is developed based on the results.

While the present invention has been described with reference to particular embodiments, those skilled in the art will recognize that many changes and variations may be made thereto without departing from the spirit and scope of the invention.

### EXAMPLE 1

Preferably, the test strips of the present invention include the following features.

| Features | |
|---|---|
| Dynamic Range Linearity | 15-200 mg/L |
| Result Output/Discrimination | Quantitative/1 mg/L |
| Precision at 30 mg/L | 5%-10% |
| Accuracy against Albumin Standard | 95% Correlation |
| Time of Test | 2-5 minutes |
| Correlation | HPLC |
| Clinical Sensitivity | 95-100% |
| Clinical Specificity | 95-100% |
| Stability at Room Temperature | 1-2 years |

### EXAMPLE 2

### Preparation of Various Test Membranes

The following test strips were prepared:

(1) A polysulfone membrane (Supor 800, Pall Membrane) dipped into Bradford reagent from Sigma

(2) A Whatman glass filter dipped into a solution containing:
5 mg Brilliant Blue G
5 mL Maleic acid buffer
2.35 ml absolute ethanol
QS to 50 mL 85% phosphoric acid

(3) A polysulfone membrane dipped into the following solution:
2 ml Brilliant Blue G concentrate from Sigma
3.334 ml 85% phosphoric acid
1.333 mL deionized water

(4) A glass fiber membrane from Whatman (GF/D) dipped into either:
(1) Sigma Bradford reagent or
(2) 2 mL Brilliant Blue G concentrarte
   3.334 mL 85% phosphoric acid
   1.334 mL deionized water

After the strips had dried, each strip was dipped into standard albumin solution (10-200 mg/dL). The color produced between one to ten minutes was observed visually.

Several glass fiber strips with Sigma Bradford reagent were prepared and tested by dipping the test pad into urine samples containing known amounts of albumin.. These strips showed color discrimination between 0, 10, 40, 100 and 200 mg/L albumin concentration at the end of five minutes.

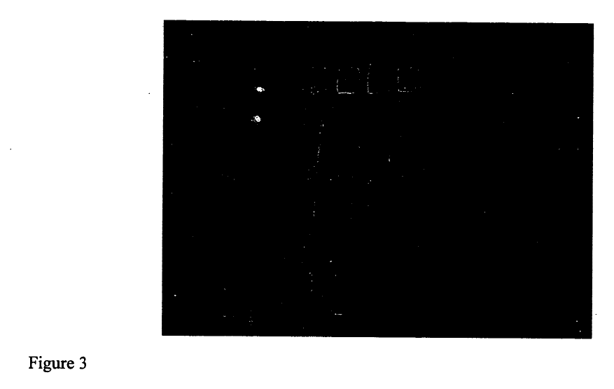

FIG. 3 represents an average result with glass fiber strips/Sigma Bradford reagent after five minutes.

What is claimed is:

1. A calorimetric test strip for detecting and semi-quantitating the amount of total albumin in a bodily sample comprising a test strip matrix, and at least one reagent area disposed on the test strip matrix comprising Coomassie Blue dye, wherein the at least one reagent area changes color shade after exposure to the sample, wherein the amount of total albumin is determined by comparing the at least one reagent area color shade after exposure to the sample to at least one reference color, said at least one reference color correlating the amount of protein determined by Bradford assay to the amount of albumin determined by HPLC.

2. The method of claim 1 wherein the at least one reagent area color shade after exposure to the sample is compared to a first color reference that correlates to a healthy amount of albumin in urine and a second color reference that correlates to an abnormally high amount of albumin in urine.

3. The calorimetric test strip according to claim 1 wherein the at least one reference color standard is adjacent to the at least one reagent area on the test strip.

4. The calorimetric test strip according to claim 1 wherein the reagent area further comprises one or more acid in admixture with the Coomassie Blue dye.

5. The calorimetric test strip according to claim 4 wherein the one or more acid is selected from acetic acid, periodic acid, phosphoric acid, selenic acid, maleic acid, oxalic acid, dichloracetic acid, and combinations thereof.

6. The calorimetric test strip of claim 5 wherein the acid is phosphoric acid.

7. The calorimetric test strip of claim 1 wherein the Coomassie Blue dye is present in an amount of from about 0.001% to about 0.1% (w/v)

8. The colorimetric test strip according to claim 4 wherein the reagent area further comprises a buffer in admixture with the Coomassie Blue dye and the acid.

9. The calorimetric test strip according to claim 4, wherein the reagent area further comprises one or more wetting agent.

10. The colorimetric test strip of claim 1 wherein the at least one color reference is generated by applying a conversion factor in the range of from 0.95 to 3.5 such that the amount of total protein in a standard urine sample from a healthy individual that is detected by Bradford assay is divided by the conversion factor to provide an estimate of the total amount of protein in the standard sample that is detected by HPLC.

11. The method of claim 10 wherein the conversion factor is in the range of from about 1.5 to about 1.7.

12. The method of claim 10 wherein the conversion factor is 1.6.

13. A colorimetric test strip for detecting and semi-quantitating the amount of total albumin in a bodily sample comprising a test strip matrix, and an effective amount of Bradford reagent dried and adhered onto at least one test pad area of the colorimetric strip, wherein total albumin in a test sample is determined by comparing the color of the test pad area after exposure to the sample to at least one reference color, said at least one reference color correlating the amount of protein determined by Bradford assay to the amount of albumin determined by HPLC.

14. The calorimetric test strip of claim 13 wherein the Bradford Reagent is present in an amount of from about 0.01% to about 1% (w/v).

15. The calorimetric test strip of claim 13 wherein the test strip comprises a test pad area adhered to each end of the test strip.

16. The calorimetric test strip of claim 13 wherein the test strip comprises a polystyrene strip having a test pad adhered thereto at one end.

17. A method for detecting and semi-quantitating the amount of albumin in a bodily sample comprising:
(a) obtaining a bodily fluid sample;
(b) contacting the bodily fluid sample with a test strip matrix having disposed thereon at least one reagent area comprising Coomassie Blue dye, wherein the at least one reagent area changes color shade after contact with the sample;
(c) comparing the at least one reagent color shade after contact with the sample with at least one reference color that correlates the amount of protein determined by Bradford assay to the amount of albumin determined by HPLC.

18. The method of claim 17 wherein the at least one reagent area color shade that develops after contact with the sample is compared to a range of reference colors that correspond to a value for total albumin in the sample.

19. The method of claim 17 wherein the body sample is a urine sample.

20. A color reference corresponding to an estimated amount of total urine in a sample, said color reference determined by correlating the amount of total protein detected in a standard sample by Bradford assay with the amount of total albumin determined in the sample by HPLC.

21. A kit comprising a plurality of calorimetric test strips for detecting and semi-quantitating the amount of total albumin in a bodily sample, said test strips comprising a test strip matrix, and an effective amount of Bradford reagent dried and adhered onto at least one test pad area of the colorimetric strip; and at least one color reference which correlates the amount of protein determined by Bradford assay to the amount of albumin determined by HPLC.

22. The kit according to claim 21 further comprising a reflectance-based color reader.
